(19) United States
(12) Patent Application Publication
(10) Pub. No.: US 2026/0351716 A1
(43) Pub. Date: Nov. 5, 2026

(54) BATTERY PACK

(71) Applicants: SK On Co., Ltd., Seoul (KR); SK INNOVATION CO., LTD., Seoul (KR)

(72) Inventors: Hyeon Jin PARK, Daejeon (KR); Se Hyeon KIM, Daejeon (KR)

(21) Appl. No.: 19/664,327

(22) Filed: Apr. 30, 2026

(30) Foreign Application Priority Data
Apr. 30, 2025 (KR) 10-2025-0057211

(51) Int. Cl. H01M 10/6556; H01M 10/613; H01M 10/647; H01M 50/209; H01M 50/358; H01M 50/505

(52) U.S. Cl. CPC H01M 10/6556; H01M 10/613; H01M 10/647; H01M 50/209; H01M 50/358; H01M 50/505

(57) ABSTRACT

Disclosed is a battery pack. The battery pack according to an embodiment of the present disclosure comprises: a pack frame including a main frame; and a cell assembly accommodated in the pack frame, wherein the main frame comprises an outer frame having a coolant inlet passage formed therein and disposed on one side of the cell assembly; a partition frame having a coolant outlet passage formed therein and disposed opposite the outer frame with respect to the cell assembly; and a front frame including a coolant inlet port in communication with the coolant inlet passage and a coolant outlet port in communication with the coolant outlet passage.

### CROSS-REFERENCE TO RELATED APPLICATION AND CLAIM OF PRIORITY

This application claims priority to Korean Patent Application No. 10-2025-0057211 filed on Apr. 30, 2025 in the Korean Intellectual Property Office (KIPO), the entire disclosure of which is incorporated by reference herein.

### BACKGROUND

### 1. Field of the Invention

The present disclosure relates to a battery pack.

### 2. Description of the Related Art

Immersion cooling is a method of directly cooling heat generated from an electronic device while the electronic device is immersed in an insulating liquid.

As requirements for rapid charging in electric vehicle battery systems are strengthened, the immersion cooling may be applied to the battery systems to replace an indirect cooling method.

A battery pack including a battery module may require extra space for accommodating the volume of a module case and for sealing the battery module.

### SUMMARY

The present disclosure relates to battery pack having a pack frame structure in which a coolant passage and an exhaust gas passage are formed.

The present disclosure relates to a battery pack that induces uniform distribution of an immersion cooling fluid (e.g., a cooling oil) under cell-to-pack (CTP) battery packaging.

A battery pack according to the present disclosure may comprise: a pack frame including a main frame; and a cell assembly accommodated in the pack frame, wherein the main frame may comprise: an outer frame having a coolant inlet passage formed therein and disposed on one side of the cell assembly; a partition frame disposed opposite the outer frame with respect to the cell assembly and having a coolant outlet passage formed therein; and a front frame including a coolant inlet port in communication with the coolant inlet passage and a coolant outlet port in communication with the coolant outlet passage.

The outer frame may comprise a first exhaust passage spaced apart from the coolant inlet passage, the partition frame may comprise a second exhaust passage spaced apart from the coolant outlet passage, and the front frame may comprise a gas outlet port in communication with the first exhaust passage and the second exhaust passage.

The front frame may comprise a front frame body coupled to the outer frame and the partition frame, and the front frame body may comprise a third through hole configured to provide fluid communication between the gas outlet port and the first and second exhaust passages.

The outer frame may comprise: a coolant inlet frame in which the coolant inlet passage is formed; and an outer exhaust frame in which the first exhaust passage is formed.

The third through hole may comprise: an exhaust connecting section formed in the front frame body along a longitudinal direction thereof; an exhaust inlet hole configured to provide fluid communication between the exhaust connecting section and the first and second exhaust passages; and an exhaust leakage hole configured to provide fluid communication between the exhaust connecting section and the gas outlet port.

The partition frame may comprise: a partition coolant frame in which the coolant outlet passage is formed; and a partition exhaust frame in which the second exhaust passage is formed.

The outer frame may comprise a first exhaust control valve penetrating and coupled to the outer exhaust frame, and the partition frame may comprise a second exhaust control valve penetrating and coupled to the partition exhaust frame.

The main frame may further comprise a wall frame connected to the outer frame and the partition frame, and the wall frame may comprise a front wall frame, a rear wall frame spaced apart from the front wall frame, and a middle wall frame disposed between the front wall frame and the rear wall frame.

An electrical component may be disposed in a space between the front frame and the front wall frame.

The coolant inlet passage may comprise: a first coolant inlet passage fluidly connecting the front wall frame and the middle wall frame; and a second coolant inlet passage fluidly connecting the front wall frame and the rear wall frame.

The space between the front wall frame and the rear wall frame may comprise a battery area through which a cooling fluid flows.

The first coolant inlet passage and the second coolant inlet passage may be formed at different positions in a height direction.

The outer frame may comprise: a first outer frame defining one side of the pack frame; and a second outer frame defining the other side of the pack frame, wherein the partition frame may be disposed between the first outer frame and the second outer frame.

The cell assembly may comprise a sub-cell assembly including a plurality of battery cells stacked in one direction and a cooling channel disposed between the plurality of battery cells, wherein the cooling channel may be in communication with the coolant inlet passage and the coolant outlet passage.

The cooling channel may comprise: a cooling channel body extending in a transverse direction; and a cooling channel hollow portion formed through the cooling channel body in the transverse direction.

The cell assembly may further comprise a busbar assembly connected to the sub-cell assembly, wherein the busbar assembly may comprise: a busbar frame; and a busbar coupled to the busbar frame and electrically connected to the battery cell, wherein a busbar hole formed in the busbar may be in communication with the cooling channel and the coolant inlet passage.

A plurality of cooling channel hollow portions may be provided, and the plurality of cooling channel hollow portions may be spaced apart in a height direction.

The pack frame may further comprise a base frame coupled to the main frame and defining a lower surface of the pack frame.

The base frame may comprise: a base center frame coupled to the outer frame and the partition frame; and a base outer frame coupled along an edge of the base center frame.

The battery pack may further comprise a pack cover part configured to cover an upper surface of the pack frame, wherein the pack cover part may comprise: a pack cover plate; and a pack cover cushioning material disposed between the pack cover plate and the cell assembly.

A battery pack according to an embodiment of the present disclosure may increase a space utilization rate by inducing uniform distribution of a cooling fluid under cell-to-pack (CTP) battery packaging.

According to the present disclosure, a portion of the pack frame may be utilized as an exhaust gas space, thereby enabling rapid relief of internal pressure within the battery pack in the event of thermal runaway occurring within the battery pack.

The battery pack of the present disclosure may be widely applied in green technology fields including electric vehicles, battery charging stations, energy storage systems (ESS), and renewable energy systems using batteries, such as photovoltaics and wind power generation.

In addition, the battery pack of the present disclosure may be used in eco-friendly electric vehicles and hybrid vehicles to suppress air pollution and greenhouse gas emissions, thereby contributing to mitigating climate change.

Furthermore, according to the present disclosure, environmentally friendly battery specifications may be satisfied by increasing energy density through the pack frame structure having secured internal space and reducing costs through a reduction in the number of parts.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic view illustrating a battery pack according to an embodiment of the present disclosure;

FIG. 2 is a perspective view of the battery pack shown in FIG. 1;

FIG. 3 is a perspective view of a pack frame shown in FIG. 2, illustrating a state in which a cell assembly is removed;

FIG. 4 is a cross-sectional view illustrating the pack frame shown in FIG. 3 taken along line E1-E2;

FIG. 5 is a cross-sectional view illustrating the pack frame shown in FIG. 3 taken along line F1-F2;

FIG. 6 is a cross-sectional view illustrating the battery pack shown in FIG. 3 taken along line G1-G2;

FIG. 7 is a cross-sectional view illustrating the battery pack shown in FIG. 3 taken along line H1-H2;

FIG. 8 is a cross-sectional view illustrating the battery pack shown in FIG. 3 taken along line I1-I2;

FIG. 9 is a cross-sectional view illustrating the battery pack shown in FIG. 3 taken along line J1-J2;

FIG. 10 is a cross-sectional view illustrating the battery pack shown in FIG. 3 taken along line K1-K2;

FIG. 11 is a cross-sectional view illustrating the battery pack shown in FIG. 1 taken along line A1-A2;

FIG. 12 is a cross-sectional view illustrating the battery pack shown in FIG. 1 taken along line B1-B2;

FIG. 13 is a cross-sectional view of the battery pack shown in FIG. 1 taken along line A1-A2, illustrating a state in which a pack cover part is attached to an outer frame;

FIG. 14 is a cross-sectional view of the battery pack shown in FIG. 1 taken along line A1-A2, illustrating a state in which the pack cover part is attached to a partition frame;

FIG. 15 is a cross-sectional view illustrating the battery pack shown in FIG. 2 taken along line C1-C2;

FIG. 16 is an enlarged view of area A of FIG. 15;

FIG. 17 is a schematic view illustrating a cooling channel according to an embodiment of the present disclosure;

FIG. 18 is a cross-sectional view illustrating the battery pack shown in FIG. 2 taken along line D1-D2;

FIG. 19 is a view illustrating the flow of a cooling fluid in a main frame forming the battery pack according to the present disclosure; and

FIG. 20 is a view illustrating the flow of exhaust gas in the main frame forming the battery pack according to the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may comprise the plural form unless the context clearly dictates otherwise.

In addition, when used to describe and define the present disclosure, terms such as “comprise,” “comprise,” “consist of,” and “have” should be interpreted in a non-exclusive manner. Unless explicitly stated otherwise, these terms should be construed to imply that the presence of the corresponding component, and not to exclude but rather comprise other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to facilitate understanding of the relationship between an element or feature and another illustrated in the drawings. These space-related terms are provided to facilitate understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

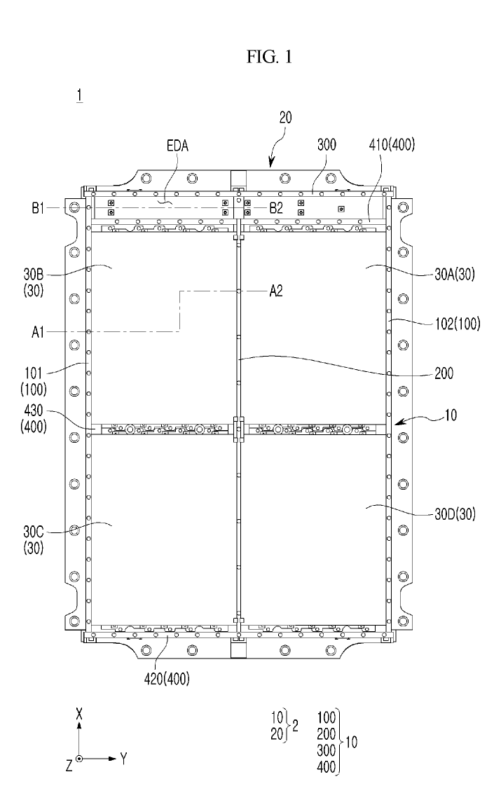

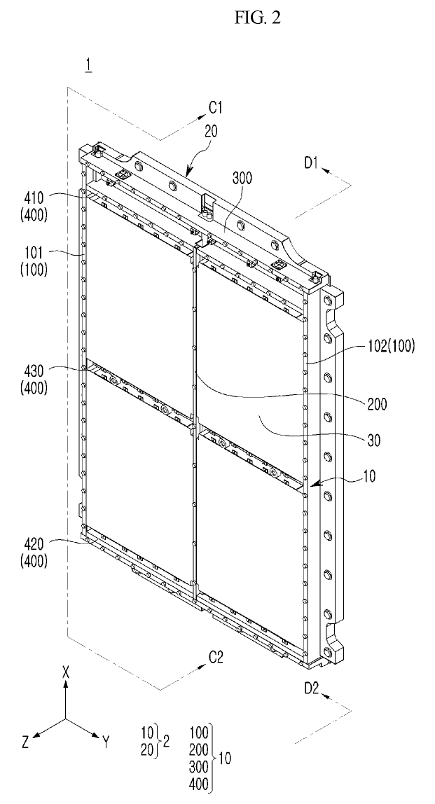

FIG. 1 is a schematic view illustrating a battery pack according to an embodiment of the present disclosure. FIG. 2 is a perspective view of the battery pack shown in FIG. 1.

In this specification, the up-down, left-right, and front-rear directions may be set based on FIG. 2. The front-rear direction may be parallel to the X-axis. For example, a positive X-axis direction may represent the forward direction, and a negative X-axis direction may represent the rearward direction.

The up-down direction may be parallel to the Z-axis. For example, a positive Z-axis direction may represent the upward direction, and a negative Z-axis direction may represent the downward direction.

The left-right direction may be parallel to the Y axis. For example, a positive Y-axis direction may represent the right side, and a negative Y-axis direction may represent the left side. The Y-axis may be perpendicular to the X-axis and the Z-axis, respectively.

Referring to FIGS. 1 and 2, the battery pack 1 may comprise a pack frame 2. The pack frame 2 may form the skeleton of the battery pack 1. The battery pack 1 may be installed in an electric vehicle or the like. The pack frame 2 may form a receiving space. For example, the pack frame 2 may accommodate a cell assembly 30. For example, the pack frame 2 may have a form that is open upward.

The pack frame 2 may comprise a main frame 10. The main frame 10 may partition the space of the battery pack 1. For example, the main frame 10 may partition the space of the battery pack 1 into a plurality of spaces that accommodate a plurality of cell assemblies 30 and electrical components (not shown).

The pack frame 2 may comprise a base frame 20. The base frame 20 may be connected or coupled to the main frame 10. The base frame 20 may define a lower surface of the battery pack 1.

The main frame 10 may comprise an outer frame 100. The outer frame 100 may define a side surface of the battery pack 1. The outer frame 100 may be formed to extend in one direction. The outer frame 100 may be formed to extend in a longitudinal direction. The longitudinal direction may be parallel to the X-axis direction. For example, the longitudinal direction may correspond to the front-rear direction. For example, the outer frame 100 may be formed to extend in the front-rear direction.

A pair of outer frames 100 may be provided. For example, the pair of outer frames 100 may define both side surfaces of the battery pack 1. The main frame 10 may comprise a first outer frame 101 and a second outer frame 102. The outer frame 100 may comprise or refer to at least one of the first outer frame 101 and the second outer frame 102.

The first outer frame 101 may define one side surface of the battery pack 1. For example, the first outer frame 101 may define the left side surface of the battery pack 1. The second outer frame 102 may define the other side surface of the battery pack 1. For example, the second outer frame 102 may define the right side surface of the battery pack 1.

The cell assembly 30 may be located between the first outer frame 101 and the second outer frame 102. For example, the first outer frame 101 and the second outer frame 102 may be located on opposite sides with respect to the cell assembly 30.

The first outer frame 101 and the second outer frame 102 may be spaced apart in a transverse direction. The transverse direction may be parallel to the Y-axis direction. The transverse direction may correspond to the left-right direction.

The main frame 10 may comprise a partition frame 200. The partition frame 200 may be located between the outer frames 100. For example, the partition frame 200 may be located between the pair of outer frames 100.

The partition frame 200 may be disposed opposite the outer frame 100 with respect to the cell assembly 30. For example, with respect to the cell assembly 30, the outer frame 100 may be disposed on one side of the cell assembly 30, and the partition frame 200 may be disposed on the other side of the cell assembly 30.

The partition frame 200 may be disposed between the first outer frame 101 and the second outer frame 102. Both surfaces of the partition frame 200 may face or be directed toward the first outer frame 101 and the second outer frame 102, respectively. For example, one surface of the partition frame 200 may face the inner surface of the first outer frame 101. For example, the other surface of the partition frame 200 may face the inner surface of the second outer frame 102.

The partition frame 200 may be formed to extend in one direction. For example, the partition frame 200 may be formed to extend in the longitudinal direction. For example, a direction in which the partition frame 200 extends may be parallel to a direction in which the outer frame 100 extends. For example, a length direction of the partition frame 200 may be parallel to a length direction of the outer frame 100.

The main frame 10 may comprise a front frame 300. The front frame 300 may define the front face of the battery pack 1. The front frame 300 may be connected or coupled to the outer frame 100 and the partition frame 200. For example, the front frame 300 may be connected or coupled to the front edge of the outer frame 100 and the front edge of the partition frame 200. For example, the front frame 300 may connect the front edge of the first outer frame 101, the front edge of the partition frame 200, and the front edge of the second outer frame 102 in the transverse direction.

The main frame 10 may comprise a wall frame 400. The wall frame 400 may partition an internal space of the battery pack 1. For example, the wall frame 400 may partition the internal space of the battery pack 1 into a plurality of spaces in the front-rear direction.

The wall frame 400 may be connected or coupled to the outer frame 100 and the partition frame 200. For example, the wall frame 400 may be connected or coupled to the first outer frame 101, the partition frame 200, and the second outer frame 102.

The wall frame 400 may comprise a front wall frame 410. The front wall frame 410 may be spaced apart from the front frame 300 in a rearward direction. The front wall frame 410 may extend from one end to the other end in the transverse direction. For example, the front wall frame 410 may extend rightward from the inner surface of the first outer frame 101 to the inner surface of the second outer frame 102.

The wall frame 400 may comprise a rear wall frame 420. The rear wall frame 420 may define the rear face of the battery pack 1. The rear wall frame 420 may be connected or coupled to the outer frame 100 and the partition frame 200. For example, the rear wall frame 420 may be connected or coupled to the rear edge of the outer frame 100 and the rear edge of the partition frame 200. For example, the rear wall frame 420 may connect the rear edge of the first outer frame 101, the rear edge of the partition frame 200, and the rear edge of the second outer frame 102 in the left-right direction.

The wall frame 400 may comprise a middle wall frame 430. The middle wall frame 430 may be connected or coupled to the outer frame 100 and the partition frame 200. The middle wall frame 430 may be located between the front wall frame 410 and the rear wall frame 420. The middle wall frame 430 may extend from one end to the other end in the transverse direction. For example, the middle wall frame 430 may extend rightward from the inner surface of the first outer frame 101 to the inner surface of the second outer frame 102 across the partition frame 200.

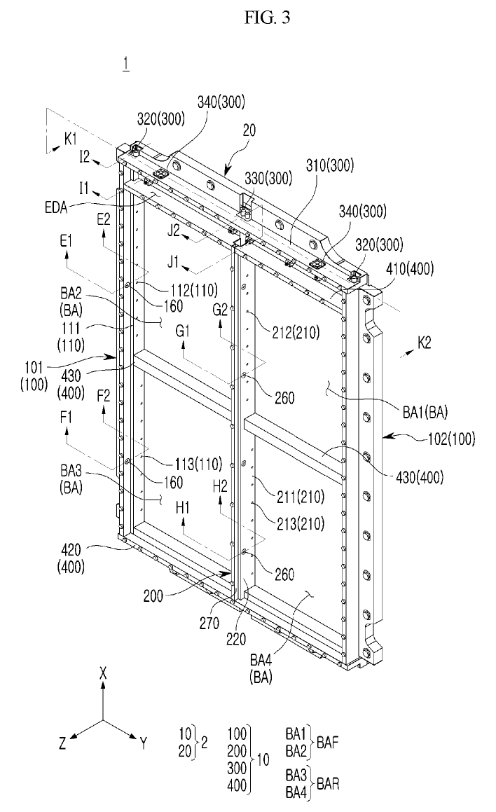

FIG. 3 is a perspective view of the battery pack shown in FIG. 1, illustrating a state in which the cell assembly 30 is removed. Referring to FIG. 3, the wall frame 400 may partition the internal space of the battery pack 1 into an electrical component area EDA and a battery area BA. A space between the front frame 300 and the front wall frame 410 may be defined as the electrical component area EDA. For example, with respect to the front wall frame 410, a space in front of the front wall frame 410 may be defined as the electrical component area EDA, and a space behind the front wall frame 410 may be defined as the battery area BA. The battery area BA may correspond to a space between the front wall frame 410 and the rear wall frame 420. A cooling fluid for immersion cooling of the battery pack 1 may be introduced into the battery area BA.

The battery area BA may be partitioned into a plurality of regions. For example, the middle wall frame 430 may partition the battery area BA in the front-rear direction. For example, the partition frame 200 may partition the battery area BA in the left-right direction. The middle wall frame 430 and the partition frame 200 may partition the battery area BA into four regions. For example, the battery area BA may be partitioned into four regions about the intersection of the middle wall frame 430 and the partition frame 200. For example, the battery area BA may comprise a first battery area BA1, a second battery area BA2, a third battery area BA3, and a fourth battery area BA4. For example, the first battery area BA1 may correspond to an area surrounded by the second outer frame 102, the partition frame 200, the front wall frame 410, and the middle wall frame 430. The first battery area BA1, the second battery area BA2, the third battery area BA3, and the fourth battery area BA4 may be arranged in a counterclockwise direction about the intersection of the middle wall frame 430 and the partition frame 200.

The battery pack 1 may comprise the base frame 20. The base frame 20 may define the lower surface of the battery pack 1. The base frame 20 may be connected or coupled to the main frame 10. For example, the base frame 20 may be connected or coupled to the lower side of the main frame 10. The base frame 20 and the main frame 10 may be stacked in a height direction. For example, the base frame 20 may be disposed below the main frame 10. The height direction may be parallel to the Z-axis direction. The height direction may correspond to the up-down direction.

The battery pack 1 may comprise the cell assembly 30. The cell assembly 30 may be accommodated in the pack frame 2. The cell assembly 30 may be disposed between the first outer frame 101 and the second outer frame 102. The cell assembly 30 may be disposed between the front wall frame 410 and the rear wall frame 420. A plurality of cell assemblies 30 may be provided. The plurality of cell assemblies 30 may comprise a first cell assembly 30A (see FIG. 1), a second cell assembly 30B (see FIG. 1), a third cell assembly 30C (see FIG. 1), and a fourth cell assembly 30D (see FIG. 1). The first cell assembly 30A, the second cell assembly 30B, the third cell assembly 30C, and the fourth cell assembly 30D may be arranged in a counterclockwise direction. The plurality of cell assemblies 30 may each be arranged to respectively correspond to a plurality of battery areas BA. For example, the first cell assembly 30A may be disposed in the first battery area BA1.

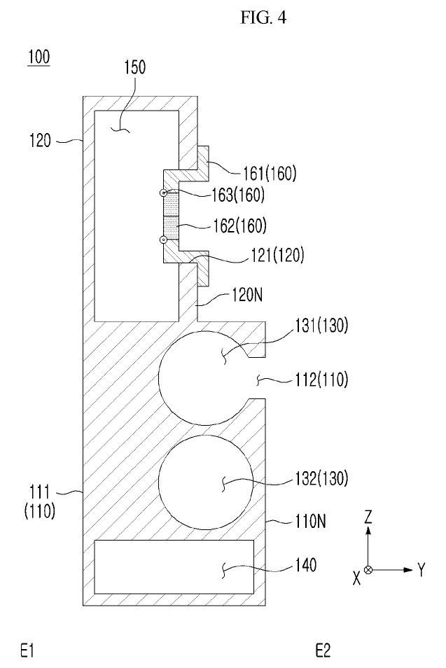

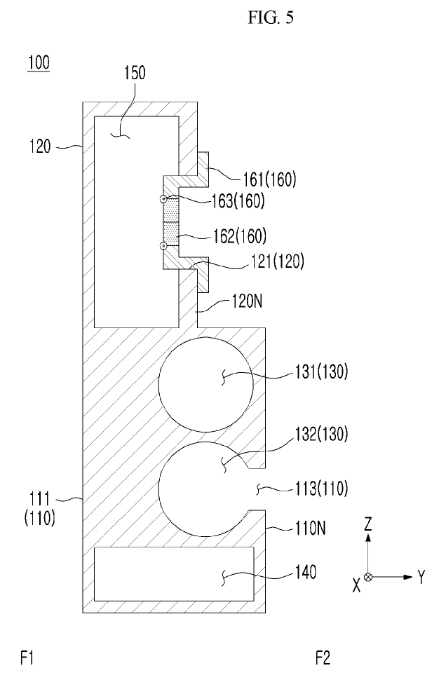

FIG. 4 is a cross-sectional view illustrating the pack frame shown in FIG. 3 taken along line E1-E2. FIG. 5 is a cross-sectional view illustrating the pack frame shown in FIG. 3 taken along line F1-F2.

A structure of the outer frame 100 will be described with reference to FIGS. 3 - 5. The outer frame 100 may comprise a coolant inlet frame 110. The coolant inlet frame 110 may comprise a coolant inlet frame body 111. The coolant inlet frame body 111 may have an elongated shape extending in one direction. For example, the coolant inlet frame body 111 may extend from one end to the other end in the front-rear direction.

The outer frame 100 may comprise an outer exhaust frame 120. The outer exhaust frame 120 may have an elongated shape extending in one direction. For example, a direction in which the outer exhaust frame 120 extends may be parallel to a direction in which the coolant inlet frame 110 extends. The outer exhaust frame 120 may be connected or coupled to the coolant inlet frame 110. For example, the outer exhaust frame 120 may be connected or coupled to an upper portion of the coolant inlet frame 110.

A step may be formed between the outer exhaust frame 120 and the coolant inlet frame 110. The inner surface of the coolant inlet frame 110 may be located closer to the inside of the battery pack 1 than the inner surface of the outer exhaust frame 120. For example, a coolant inlet frame inner surface 110N may be located closer to the inside of the battery pack 1 than an outer exhaust frame inner surface 120N. The coolant inlet frame inner surface 110N and the outer exhaust frame inner surface 120N may face or be directed toward the battery area BA.

The outer frame 100 may comprise a coolant inlet passage 130. The coolant inlet passage 130 may be formed in the coolant inlet frame 110. For example, the coolant inlet passage 130 may be formed to penetrate the front and rear faces of the coolant inlet frame 110. For example, the coolant inlet passage 130 may be in communication with the front and rear faces of the coolant inlet frame 110.

A plurality of coolant inlet passages 130 may be provided. For example, a pair of coolant inlet passages 130 may be provided. The pair of coolant inlet passages 130 may comprise a first coolant inlet passage 131 and a second coolant inlet passage 132. The pair of coolant inlet passages 130 may be spaced apart in a vertical direction. The first coolant inlet passage 131 and the second coolant inlet passage 132 may be formed at different positions in the height direction. The first coolant inlet passage 131 may be located above the second coolant inlet passage 132.

The coolant inlet frame 110 may comprise a first coolant outlet hole 112 and a second coolant outlet hole 113. The coolant outlet holes 112 and 113 may be openings formed in the coolant inlet frame body 111. The coolant outlet holes 112 and 113 may provide fluid communication between the exterior of the outer frame 100 and the coolant inlet passage 130. For example, the coolant outlet holes 112 and 113 may provide fluid communication between the coolant inlet frame inner surface 110N and a portion of the periphery of the coolant inlet passage 130. The coolant outlet holes 112 and 113 may be in communication with the battery area BA and the coolant inlet passage 130.

The first coolant outlet hole 112 may be in communication with the first coolant inlet passage 131. The first coolant outlet hole 112 may be in communication with a front battery area BAF. The front battery area BAF may comprise the first battery area BA1 and the second battery area BA2. The front battery area BAF may correspond to the space between the front wall frame 410 and the middle wall frame 430.

The second coolant outlet hole 113 may be in communication with the second coolant inlet passage 132. The coolant outlet holes 112 and 113 may be in communication with a rear battery area BAR. The rear battery area BAR may comprise the third battery area BA3 and the fourth battery area BA4. The rear battery area BAR may correspond to the space between the rear wall frame 420 and the middle wall frame 430.

The coolant inlet passages 131 and 132 may each be in communication with different battery areas BA. The coolant outlet holes 112 and 113 in communication with the coolant inlet passages 131 and 132 may each be in communication with different battery areas BA. For example, the cooling fluid flowing through the first coolant inlet passage 131 may be supplied to the front battery area BAF through the first coolant outlet hole 112. For example, the cooling fluid flowing through the second coolant inlet passage 132 may be supplied to the rear battery area BAR through the second coolant outlet hole 113. Meanwhile, the first coolant inlet passage 131 may be formed only up to the front battery area BAF. For example, the first coolant inlet passage 131 may be formed only from the front face of the coolant inlet frame 110 to the middle wall frame 430. This means that, during a process of forming the coolant inlet passage 130 using a molding method other than extrusion molding, the first coolant inlet passage 131 may not exist in the rear battery area BAR.

The outer frame 100 may comprise an outer frame hollow portion 140. The outer frame hollow portion 140 may be formed in the coolant inlet frame 110. For example, the outer frame hollow portion 140 may be formed to penetrate the front and rear faces of the coolant inlet frame 110. For example, the outer frame hollow portion 140 may be in communication with the front and rear faces of the coolant inlet frame 110.

The outer frame hollow portion 140 may be formed below the coolant inlet passage 130. For example, the outer frame hollow portion 140 may be formed below the second coolant inlet passage 132. The outer frame hollow portion 140 may define a space for coupling between the main frame 10 and the base frame 20.

The outer frame 100 may comprise a first exhaust passage 150. The first exhaust passage 150 may be formed in the outer exhaust frame 120. For example, the first exhaust passage 150 may be formed to penetrate the front and rear faces of the outer exhaust frame 120. For example, the first exhaust passage 150 may be in communication with the front and rear faces of the outer exhaust frame 120.

The outer exhaust frame 120 may comprise a first exhaust gas inlet hole 121. The first exhaust gas inlet hole 121 may be an opening formed in the outer exhaust frame 120. The first exhaust gas inlet hole 121 may provide fluid communication between the exterior of the outer frame 100 and the first exhaust passage 150. For example, the first exhaust gas inlet hole 121 may provide fluid communication between the outer exhaust frame inner surface 120N and a portion of the periphery of the first exhaust passage 150. The first exhaust gas inlet hole 121 may be in communication with the battery area BA and the first exhaust passage 150.

The outer frame 100 may comprise a first exhaust control valve 160. The first exhaust control valve 160 may be coupled to the outer exhaust frame 120. For example, the first exhaust control valve 160 may be coupled to the outer exhaust frame 120 at the first exhaust gas inlet hole 121.

The first exhaust control valve 160 may comprise a first exhaust control valve body 161. The first exhaust control valve body 161 may be coupled to the outer exhaust frame 120 by penetrating through the first exhaust gas inlet hole 121. The first exhaust control valve body 161 may be coupled to the outer exhaust frame 120 using any one of the coupling methods including press fitting, screwing, bonding, and welding.

The first exhaust control valve 160 may comprise a first exhaust control valve membrane 162. The first exhaust control valve membrane 162 may be disposed in an opening formed in the first exhaust control valve body 161. For example, the first exhaust control valve membrane 162 may be disposed on an opening formed to extend through the first exhaust control valve body 161 in the left-right direction.

The first exhaust control valve membrane 162 may be opened or closed by a pressure difference between opposite sides thereof. For example, when a difference between the internal pressure of the outer frame 100 and the internal pressure of the first exhaust passage 150 is greater than a preset reference pressure, the first exhaust control valve membrane 162 may be opened.

The first exhaust control valve 160 may comprise a first exhaust control valve elastic body 163. The first exhaust control valve elastic body 163 may connect the first exhaust control valve body 161 and the first exhaust control valve membrane 162. The first exhaust control valve membrane 162 may be pivotally coupled to the first exhaust control valve body 161 by the first exhaust control valve elastic body 163.

The first exhaust control valve elastic body 163 may have a spring shape having an elastic restoring force. For example, the first exhaust control valve elastic body 163 may comprise a torsion spring. When pressure is applied to one side of the first exhaust control valve membrane 162, the first exhaust control valve membrane 162 may be pivotable about the first exhaust control valve elastic body 163. For example, the first exhaust control valve membrane 162 may be pivoted toward the first exhaust passage 150 by pressure acting on the first exhaust control valve 160 from outside the outer exhaust frame 120.

The first exhaust control valve membranes 162 may be symmetrically disposed in an opening formed to extend through the first exhaust control valve body 161. For example, the first exhaust control valve membranes 162 symmetrically disposed in the up-down direction may be pivoted in opposite directions. When the pressure acting on the first exhaust control valve 160 is removed, the first exhaust control valve membranes 162 may return to respective original positions thereof by an elastic restoring force of the first exhaust control valve elastic body 163.

The coolant inlet frame 110 and the outer exhaust frame 120 may be integrally formed as a single member. The coolant inlet frame 110 and the outer exhaust frame 120 may be formed through a single process. For example, the coolant inlet frame 110 and the outer exhaust frame 120 may be formed through an extrusion process.

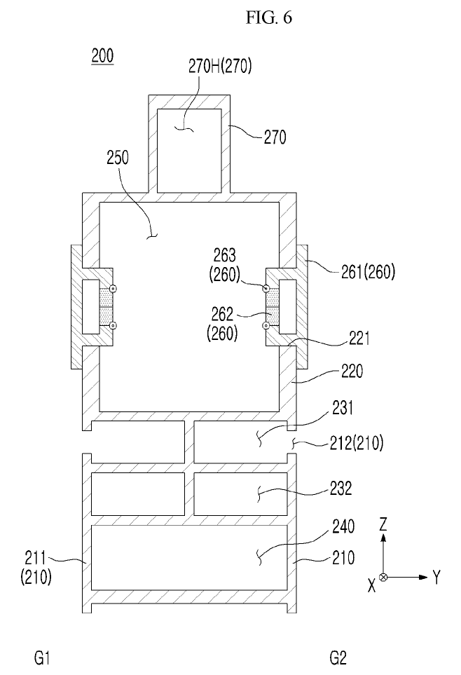

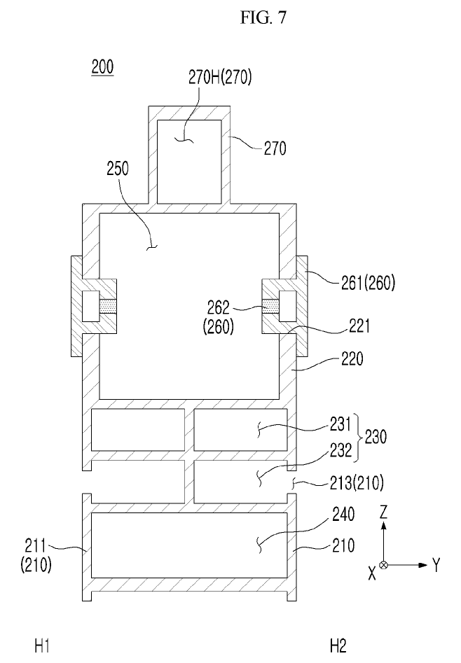

FIG. 6 is a cross-sectional view illustrating the battery pack shown in FIG. 3 taken along line G1-G2. FIG. 7 is a cross-sectional view illustrating the battery pack shown in FIG. 3 taken along line H1-H2.

A structure of the partition frame 200 will be described with reference to FIGS. 3, 6 and 7. The partition frame 200 may comprise a partition coolant frame 2100. The partition coolant frame 210 may comprise a partition coolant frame body 211. The partition coolant frame body 211 may have an elongated shape extending in one direction. For example, the partition coolant frame body 211 may extend from one end to the other end in the front-rear direction.

The partition frame 200 may comprise a partition exhaust frame 220. The partition exhaust frame 220 may have an elongated shape extending in one direction. For example, a direction in which the partition exhaust frame 220 extends may be parallel to a direction in which the partition coolant frame 210 extends. The partition exhaust frame 220 may be connected or coupled to the partition coolant frame 210. For example, the partition exhaust frame 220 may be connected or coupled to an upper portion of the partition coolant frame 210.

The partition frame 200 may comprise a coolant outlet passage 230. The coolant outlet passage 230 may be formed in the partition coolant frame 210. For example, the coolant outlet passage 230 may be formed to penetrate the front and rear faces of the partition coolant frame 210. For example, the coolant outlet passage 230 may be in communication with the front and rear faces of the partition coolant frame 210.

A plurality of coolant outlet passages 230 may be provided. For example, a pair of coolant outlet passages 230 may be provided. The pair of coolant outlet passages 230 may be spaced apart in the vertical direction. The pair of coolant outlet passages 230 may comprise a first coolant outlet passage 231 and a second coolant outlet passage 232. The first coolant outlet passage 231 may be located above the second coolant outlet passage 232.

The partition coolant frame 210 may comprise a first coolant recovery hole 212 and a second coolant recovery hole 213. The coolant recovery holes 212 and 213 may be openings formed in the partition coolant frame body 211. The coolant recovery holes 212 and 213 may provide fluid communication between the exterior of the partition frame 200 and the coolant outlet passage 230. For example, the coolant recovery holes 212 and 213 may provide fluid communication between the outer surface of the partition coolant frame body 211 and a portion of the periphery of the coolant outlet passage 230.

The first coolant recovery hole 212 may be in communication with the first coolant outlet passage 231. The first coolant recovery hole 212 may be in communication with the front battery area BAF. The second coolant recovery hole 213 may be in communication with the second coolant outlet passage 232. The second coolant recovery hole 213 may be in communication with the rear battery area BAR.

The coolant outlet passages 231 and 232 may each be in communication with different battery areas BA. The coolant recovery holes 212 and 213 in communication with the coolant outlet passages 231 and 232 may each be in communication with different battery areas BA. For example, a cooling fluid flowing through the first coolant outlet passage 231 may flow from the front battery area BAF to the first coolant outlet passage 231 through the first coolant recovery hole 212. For example, a cooling fluid flowing through the second coolant outlet passage 232 may flow from the rear battery area BAR to the second coolant outlet passage 232 through the second coolant recovery hole 213.

The partition frame 200 may comprise a partition frame hollow portion 240. The partition frame hollow portion 240 may be formed in the partition coolant frame 210. For example, the partition frame hollow portion 240 may be formed to penetrate the front and rear faces of the partition coolant frame 210. For example, the partition frame hollow portion 240 may be in communication with the front and rear faces of the partition coolant frame 210.

The partition frame hollow portion 240 may be formed below the coolant outlet passage 230. For example, the partition frame hollow portion 240 may be formed below the second coolant outlet passage 232. The partition frame hollow portion 240 may define a space for coupling between the main frame 10 and the base frame 20. For example, the partition frame hollow portion 240 may define a space for coupling between the partition frame 200 and the base frame 20.

The partition frame 200 may comprise a second exhaust passage 250. The second exhaust passage 250 may be formed in the partition exhaust frame 220. For example, the second exhaust passage 250 may be formed to penetrate the front and rear faces of the partition exhaust frame 220. For example, the second exhaust passage 250 may be in communication with the front and rear faces of the partition exhaust frame 220.

The partition frame 200 may comprise a second exhaust gas inlet hole 221. The second exhaust gas inlet hole 221 may be an opening formed in the partition exhaust frame 220. The second exhaust gas inlet hole 221 may provide fluid communication between the exterior of the partition frame 200 and the second exhaust passage 250. For example, the second exhaust gas inlet hole 221 may provide fluid communication between the outer surface of the partition coolant frame 210 and a portion of the periphery of the second exhaust passage 250. An exhaust gas generated in the battery area BA may flow into the second exhaust passage 250 through the second exhaust gas inlet hole 221.

The partition frame 200 may comprise a second exhaust control valve 260. The second exhaust control valve 260 may be coupled to the partition exhaust frame 220. For example, the second exhaust control valve 260 may be coupled to the partition exhaust frame 220 at the second exhaust gas inlet hole 221.

The second exhaust control valve 260 may comprise a second exhaust control valve body 261. The second exhaust control valve body 261 may be coupled to the partition exhaust frame 220 by penetrating through the second exhaust gas inlet hole 221. The second exhaust control valve body 261 may be coupled to the partition exhaust frame 220 using any one of the coupling methods including press fitting, screwing, bonding, and welding.

The second exhaust control valve 260 may comprise a second exhaust control valve membrane 262. The second exhaust control valve membrane 262 may be disposed in an opening formed in the second exhaust control valve body 261. For example, the second exhaust control valve membrane 262 may be disposed on an opening formed to extend through the second exhaust control valve body 261 in the left-right direction.

The second exhaust control valve membrane 262 may be opened or closed by a pressure difference between opposite sides thereof. For example, when a difference between the external pressure of the partition frame 200 and the internal pressure of the second exhaust passage 250 is greater than a preset reference pressure, the second exhaust control valve membrane 262 may be opened.

The second exhaust control valve 260 may comprise a second exhaust control valve elastic body 263. The second exhaust control valve elastic body 263 may connect the second exhaust control valve body 261 and the second exhaust control valve membrane 262. The second exhaust control valve membrane 262 may be pivotally coupled to the second exhaust control valve body 261 by the second exhaust control valve elastic body 263.

The second exhaust control valve elastic body 263 may have a spring shape having an elastic restoring force. For example, the second exhaust control valve elastic body 263 may comprise a torsion spring. When pressure is applied to one side of the second exhaust control valve membrane 262, the second exhaust control valve membrane 262 may be pivotable about the second exhaust control valve elastic body 263. For example, the second exhaust control valve membrane 262 may be pivotable toward the second exhaust passage 250 by pressure acting on the second exhaust control valve 260 from outside the partition exhaust frame 220.

The second exhaust control valve membranes 262 may be symmetrically disposed in an opening formed to extend through the second exhaust control valve body 261. For example, the second exhaust control valve membranes 262 symmetrically disposed in the up-down direction may be pivoted in opposite directions. When the pressure acting on the second exhaust control valve 260 is removed, the second exhaust control valve membranes 262 may return to respective original positions thereof by an elastic recovery force of the second exhaust control valve elastic body 263.

The partition frame 200 may comprise a partition frame bracket 270. The partition frame bracket 270 may have an elongated shape extending in one direction. For example, a direction in which the partition frame bracket 270 extends may be parallel to a direction in which the partition coolant frame 210 extends. The partition frame bracket 270 may be connected or coupled to the partition coolant frame 210. For example, the partition frame bracket 270 may be connected or coupled to an upper portion of the partition exhaust frame 220.

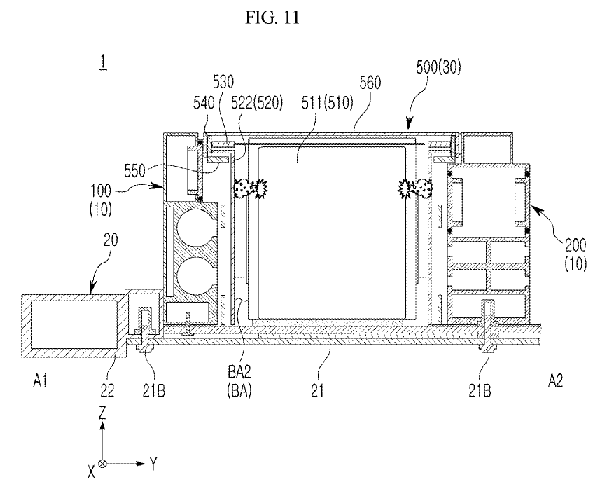

The partition frame bracket 270 may comprise a cover coupling section 270H. For example, the cover coupling section 270H may be formed to penetrate the front and rear faces of the partition frame bracket 270. For example, the cover coupling section 270H may be fluidly connected to the front and rear faces of the partition frame bracket 270. The cover coupling section 270H may define a space for coupling between the pack cover part 40 (see FIG. 11) and the partition frame bracket 270. For example, the pack cover part 40 (see FIG. 11) and the upper surface of the partition frame bracket 270 may be screw-coupled to each other.

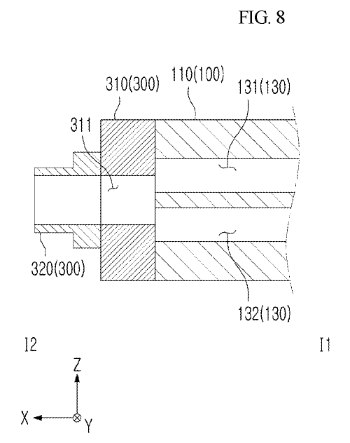

Referring to FIG. 8, the front frame 300 may comprise a front frame body 310. The front frame 300 may define the front face of the battery pack 1. The front frame body 310 may be connected or coupled to the front end of the outer frame 100 and the front end of the partition frame 200.

The front frame 300 may comprise a coolant inlet port 320. The coolant inlet port 320 may be connected or coupled to the front frame body 310. For example, the coolant inlet port 320 may be connected or coupled to the front face of the front frame body 310.

The coolant inlet port 320 may be in communication with the coolant inlet passage 130. Both surfaces of the front frame body 310 may be in communication with the coolant inlet port 320 and the coolant inlet passage 130, respectively. For example, a first through hole 311 formed through the front and rear faces of the front frame body 310 may be in communication with the coolant inlet port 320 and the coolant inlet passage 130. For example, a cooling fluid flowing through the coolant inlet port 320 may be supplied to the coolant inlet passage 130.

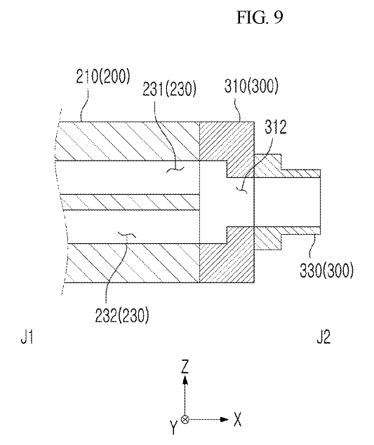

Referring to FIG. 9, the front frame 300 may comprise a coolant outlet port 330. The coolant outlet port 330 may be connected or coupled to the front frame body 310. For example, the coolant outlet port 330 may be connected or coupled to the front face of the front frame body 310.

The coolant outlet port 330 may be in communication with the coolant outlet passage 230. Both surfaces of the front frame body 310 may be in communication with the coolant outlet port 330 and the coolant outlet passage 230, respectively. For example, a second through hole 312 formed through the front and rear faces of the front frame body 310 may be in communication with the coolant outlet port 330 and the coolant outlet passage 230. For example, a cooling fluid flowing through the coolant outlet passage 230 may be discharged through the coolant outlet port 330.

A cooling fluid introduced into the battery pack 1 through the coolant inlet port 320 may flow into the coolant inlet passage 130 of the coolant inlet frame 110. The cooling fluid in the coolant inlet passage 130 may be supplied to the battery area BA. Heat dissipated from the cell assembly 30 disposed in the battery area BA may be absorbed by the cooling fluid supplied to the battery area BA. The cooling fluid having absorbed thermal energy may flow into the coolant outlet passage 230 of the partition coolant frame 210. The cooling fluid in the coolant outlet passage 230 may be discharged to the outside of the battery pack 1 through the coolant outlet port 330.

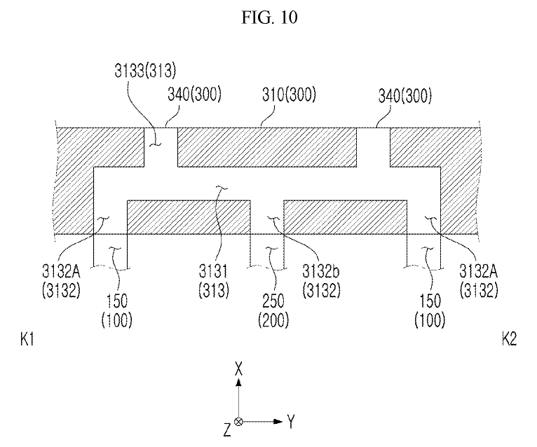

Referring to FIG. 10, the front frame 300 may comprise a gas outlet port 340. The gas outlet port 340 may be connected or coupled to the front frame body 310. For example, the gas outlet port 340 may be connected or coupled to the front face of the front frame body 310.

The gas outlet port 340 may be in communication with the exhaust passages 150 and 250. Both surfaces of the front frame body 310 may be in communication with the gas outlet port 340 and the exhaust passages 150 and 250, respectively. For example, the front face of the front frame body 310 may be in communication with the gas outlet port 340. The rear face of the front frame body 310 may be in communication with the exhaust passages 150 and 250. A third through hole 313 formed in the front frame body 310 may be in communication with the gas outlet port 340 and the exhaust passages 150 and 250. For example, an exhaust gas flowing through the exhaust passages 150 and 250 may be discharged through the gas outlet port 340.

The third through hole 313 may form a flow passage that is in communication with the front and rear faces of the front frame body 310. The third through hole 313 may comprise an exhaust inlet hole 3132. A portion of the periphery of the exhaust inlet hole 3132 may be in communication with the exhaust passages 150 and 250. The third through hole 313 may comprise an exhaust connecting section 3131. The exhaust connecting section 3131 may be connected to the exhaust inlet hole 3132. For example, a portion of the periphery of the exhaust connecting section 3131 may be connected to the exhaust inlet hole 3132. The third through hole 313 may comprise an exhaust leakage hole 3133. The exhaust leakage hole 3133 may be connected to the exhaust connecting section 3131. For example, a portion of the periphery of the exhaust leakage hole 3133 may be connected to the exhaust connecting section 3131.

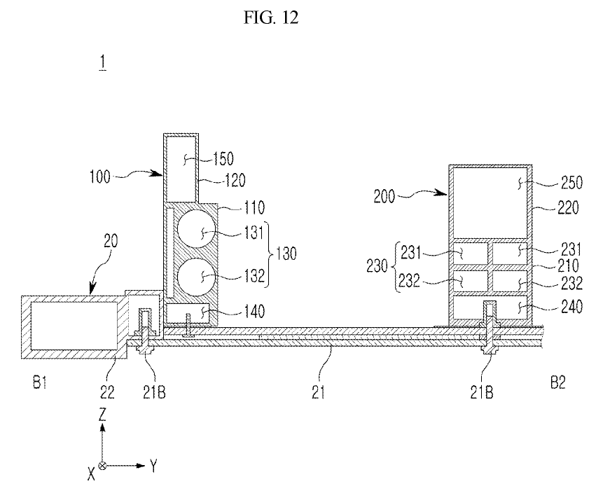

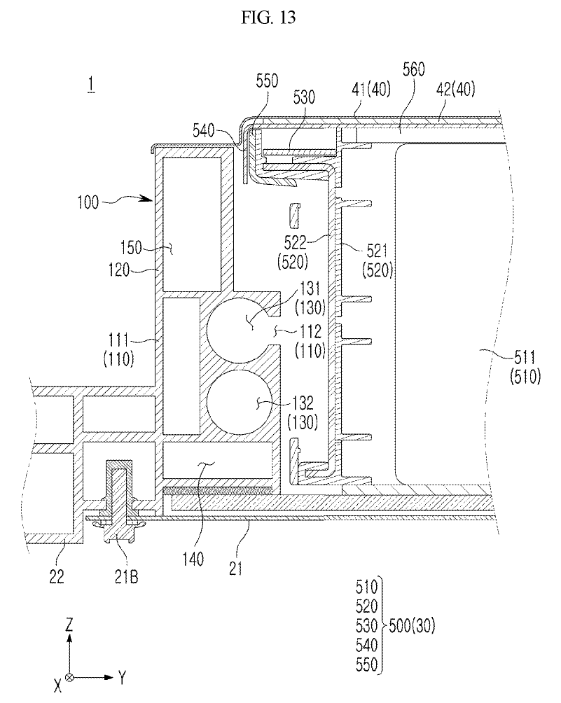

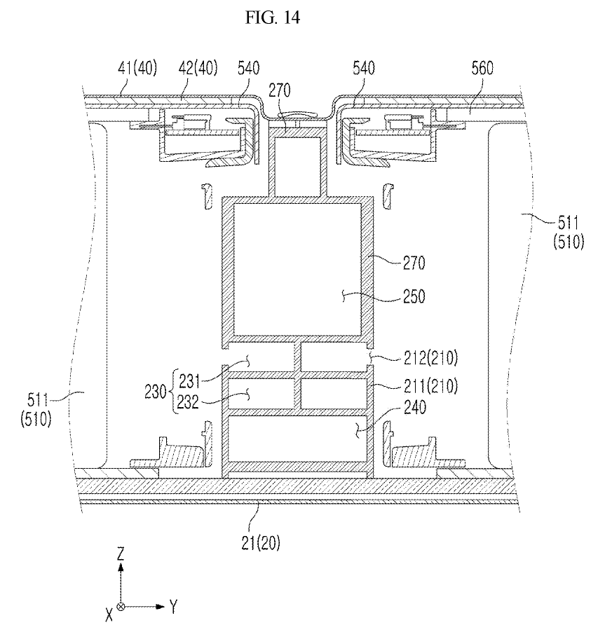

FIG. 11 is a cross-sectional view illustrating the battery pack shown in FIG. 1 taken along line A1-A2. FIG. 12 is a cross-sectional view illustrating the battery pack shown in FIG. 1 taken along line B1-B2. FIG. 13 is a cross-sectional view of the battery pack shown in FIG. 1 taken along line A1-A2, illustrating a state in which the pack cover part 40 is coupled to the outer frame 100. FIG. 14 is a cross-sectional view of the battery pack shown in FIG. 1 taken along line A1-A2, illustrating a state in which the pack cover part 40 is coupled to the partition frame 200.

Referring to FIGS. 11 - 14, the base frame 20 may comprise a base center frame 21. The base center frame 21 may be disposed below the main frame 10. For example, the base center frame 21 and the main frame 10 may be stacked in the up-down direction.

The base center frame 21 may be coupled to the partition frame 200 and the outer frame 100. For example, the base center frame 21 and the partition coolant frame 210 may be fastened by a frame fixing means 21B. For example, the frame fixing means 21B may pass through lower surfaces of the base center frame 21 and the partition coolant frame 210 and extend into the partition frame hollow portion 240.

The base frame 20 may comprise a base outer frame 22. The base outer frame 22 may be connected or coupled to the base center frame 21. The base outer frame 22 may define a periphery of the base frame 20. For example, the base outer frame 22 may be connected or coupled along an edge of the base center frame 21. When viewed from above, the base outer frame 22 may be exposed outside the main frame 10.

The battery pack 1 may be coupled to an electric power device. The base outer frame 22 may enable coupling to the electric power device. For example, the base outer frame 22 may be coupled to the electric power device, such as an electric vehicle, through a fastening means penetrating upper and lower surfaces of the base outer frame 22.

The cell assembly 500 of FIG. 11 may be identical to the cell assembly 30 of FIG. 1. The cell assembly 500 may comprise a sub-cell assembly 510. The sub-cell assembly 510 may be located in the battery area BA. The sub-cell assembly 510 may be disposed between the outer frame 100 and the partition frame 200. The sub-cell assembly 510 may comprise a plurality of battery cells 511. The plurality of battery cells 511 may be stacked in one direction. For example, the plurality of battery cells 511 may be stacked in the front-rear direction.

The cell assembly 500 may comprise a busbar assembly 520. The busbar assembly 520 may be electrically connected or coupled to the sub-cell assembly 510. The busbar assembly 520 may be electrically connected or coupled to each of the plurality of battery cells 511. The busbar assembly 520 may comprise a busbar frame 521. The busbar frame 521 may form an overall framework of the busbar assembly 520. The busbar frame 521 may be disposed on one side or both sides of the sub-cell assembly 510. For example, the busbar frame 521 may extend in the front-rear direction on a left side or a right side of the sub-cell assembly 510. The busbar assembly 520 may comprise a busbar 522. The busbar 522 may be connected or coupled to the busbar frame 521. For example, the busbar 522 may be fastened to the busbar frame 521 through frame rivets protruding from the busbar frame 521.

The cell assembly 500 may comprise a connection board 530. The connection board 530 may be connected or coupled to the busbar assembly 520. For example, the connection board 530 may extend in the front-rear direction on an upper end of the busbar frame 521. The connection board 530 may be connected to the busbar 522. The connection board 530 may transmit and receive electrical signals to and from the plurality of battery cells 511 through the busbar 522.

The cell assembly 500 may comprise a cell assembly cover 540. The cell assembly cover 540 may define an upper surface of the cell assembly 500. The cell assembly cover 540 may cover the upper surface of the sub-cell assembly 510 and the upper surface of the busbar assembly 520.

The cell assembly 500 may comprise an insulating member 550. The insulating member 550 may be disposed between the busbar assembly 520 and the cell assembly cover 540. The insulating member 550 may provide electrical insulation between the connection board 530 disposed on the busbar assembly 520 and an exterior of the cell assembly 500.

The cell assembly 500 may comprise a gap filler 560. The gap filler 560 may be disposed between the sub-cell assembly 510 and the cell assembly cover 540. The gap filler 560 may fill a space between the battery cell 511 and the cell assembly cover 540. The gap filler 560 may fill a space between the cooling channel 512 and the cell assembly cover 540.

The battery pack 1 may comprise a pack cover part 40. The pack cover part 40 may define the upper surface of the battery pack 1. The pack cover part 40 may comprise a pack cover plate 41. The pack cover plate 41 may cover the outer frame 100, the partition frame 200, the front frame 300, and the cell assembly 500. The pack cover plate 41 may have a curved shape. For example, the pack cover plate 41 may form a curved surface to match the heights of the outer frame 100, the cell assembly 500, and the partition frame 200.

The pack cover part 40 may comprise a pack cover cushioning material 42. The pack cover cushioning material 42 may be disposed between the pack cover plate 41 and the cell assembly 500. For example, the pack cover cushioning material 42 may be disposed between the pack cover plate 41 and the cell assembly cover 540. The pack cover cushioning material 42 may prevent interference between the pack cover part 40 and the cell assembly 500 and may mitigate an impact applied from outside the pack cover part 40 to the cell assembly 500. The pack cover part 40 may protect electrical components accommodated in the electrical component area EDA and the cell assembly 500 accommodated in the battery area BA.

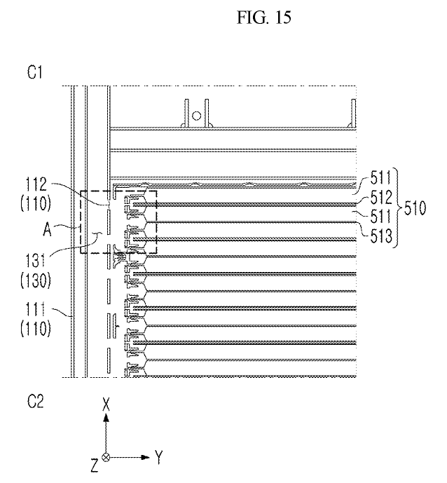

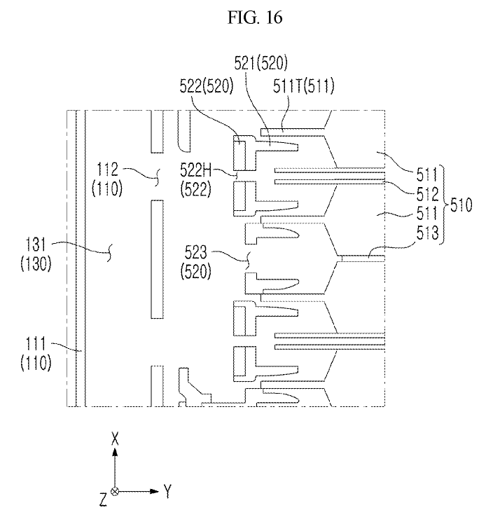

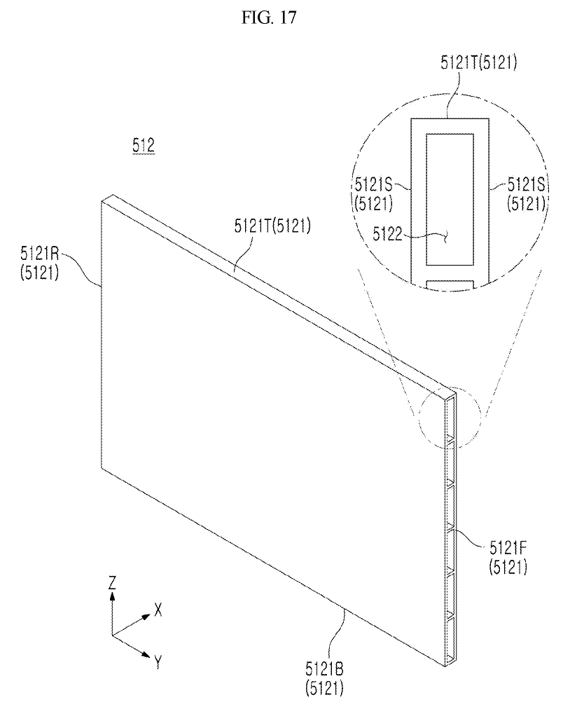

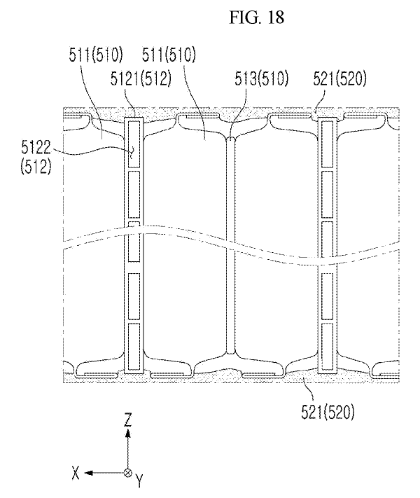

FIG. 15 is a cross-sectional view illustrating the battery pack shown in FIG. 2 taken along line C1-C2. FIG. 16 is an enlarged view of area A of FIG. 15. FIG. 17 is a schematic view illustrating the cooling channel according to an embodiment of the present disclosure. FIG. 18 is a cross-sectional view illustrating the battery pack shown in FIG. 2 taken along line D1-D2.

A structure for performing immersion cooling on the cell assembly 500 using a cooling fluid flowing through the main frame 10 will be described with reference to FIGS. 15 - 18.

The battery cell 511 may comprise a battery cell tab 511T. The battery cell tab 511T may be formed to protrude from the battery cell 511 in one direction. For example, the battery cell tab 511T may protrude from one side or both sides of the battery cell 511 in the longitudinal direction. For example, the battery cell tab 511T may extend from the battery cell 511 in the transverse direction. The battery cell tab 511T may be electrically connected or coupled to the busbar 522 of the busbar assembly 520.

The sub-cell assembly 510 may comprise a cooling channel 512. The cooling channel 512 may be disposed between a pair of adjacent battery cells 511. The cooling channel 512 may be in close contact with a surface of each of the pair of adjacent battery cells 511. For example, one surface of the cooling channel 512 may be in close contact with any one of the pair of adjacent battery cells 511. The cooling channel 512 may transfer cooling energy to the pair of adjacent battery cells 511. The cooling fluid flowing through the cooling channel 512 may absorb heat generated from the pair of adjacent battery cells 511. The pair of adjacent battery cells 511 may be cooled by the cooling fluid flowing through the cooling channel 512.

The sub-cell assembly 510 may comprise a cell buffer member 513. The cell buffer member 513 may be disposed between the battery cells 511. The cell buffer member 513 may be elastically deformable. The cell buffer member 513 may adjust a stacking thickness of the sub-cell assembly 510. The sub-cell assembly 510 having a plurality of stacked battery cells 511 may experience variations in the stacking thickness due to a swelling phenomenon of the battery cells 511. The cell buffer member 513, which is elastically deformable in the stacking direction, may adjust a spacing between the battery cells 511.

The cooling fluid introduced into the coolant inlet passage 130 formed in the coolant inlet frame 110 may be supplied to the cell assembly 500 disposed in the battery area BA through the coolant outlet holes 112 and 113. For example, the cooling fluid introduced into the first coolant inlet passage 131 may be supplied to the second cell assembly 30B located in the second battery area BA2.

The cooling fluid discharged through the coolant outlet holes 112 and 113 may be supplied to the sub-cell assembly 510 through the busbar assembly 520. The busbar assembly 520 may comprise a busbar hole 522H. The busbar hole 522H may be formed to penetrate both surfaces of the busbar assembly 520. The busbar hole 522H may be formed to penetrate both surfaces of the busbar 522 and the busbar frame 521. The busbar hole 522H formed in the busbar 522 may be in communication with the cooling channel 512 and the coolant inlet passage 130. For example, the cooling fluid supplied to the battery area BA through the coolant inlet passage 130 may be supplied to the cooling channel 512 of the sub-cell assembly 510 through the busbar hole 522H. The cooling fluid may be introduced into the cooling channel 512.

In the cell-to-pack (CTP) battery packaging structure, the battery pack 1 according to the present disclosure may induce uniform distribution of an immersion cooling fluid. The cooling channel 512 may be connected to the coolant inlet passage 130 and the coolant outlet passage 230. The cooling fluid introduced into the battery area BA in which the plurality of battery cells 511 are accommodated through the coolant inlet passage 130 and the cooling channel 512 may flow through the coolant outlet passage 230 of the partition coolant frame 210 and be discharged to the outside of the battery pack 1.

The coolant inlet passage 130 and the coolant outlet passage 230 are disposed in the pack frame 2 that forms the framework of the battery pack 1, thereby increasing the space utilization rate of the battery pack 1.

Referring to FIG. 17, the cooling channel 512 may extend from one end to the other end in one direction. For example, the cooling channel 512 may extend from one end to the other end in the positive Y-axis direction. The cooling channel 512 may comprise a cooling channel body 5121. The cooling channel body 5121 may form the framework of the cooling channel 512. The cooling channel body 5121 may comprise a cooling channel body front portion 5121F and a cooling channel body rear portion 5121R. The cooling channel 512 may extend from the cooling channel body front portion 5121F to the cooling channel body rear portion 5121R in the negative Y-axis direction. The cooling channel body 5121 may comprise a cooling channel body upper portion 5121T and a cooling channel body lower portion 5121B. The cooling channel body upper portion 5121T and the cooling channel body lower portion 5121B may be connected or coupled to the gap filler 560. For example, an upper end of the cooling channel body upper portion 5121T may be inserted into the gap filler 560.

The cooling channel body 5121 may comprise a pair of cooling channel body side portions 5121S. A distance between the pair of cooling channel body side portions 5121S may correspond to the thickness of the cooling channel body 5121.

The cooling channel 512 may comprise a cooling channel hollow portion 5122. The cooling channel hollow portion 5122 may be formed through the cooling channel body 5121. The cooling channel hollow portion 5122 may be connected to or in communication with the cooling channel body front portion 5121F and the cooling channel body rear portion 5121R. A plurality of cooling channel hollow portions 5122 may be provided. The plurality of cooling channel hollow portions 5122 may be spaced apart in the up-down direction. The plurality of cooling channel hollow portions 5122 spaced apart in the up-down direction may enable partitioned cooling of the surfaces of an adjacent pair of battery cells 511. For example, the surface areas of the battery cells 511 partitioned in the up-down direction may be simultaneously cooled by the plurality of cooling channel hollow portions 5122.

A structure for exhausting exhaust gas generated in the sub-cell assembly 510 will be described with reference to FIGS. 11 - 16. The battery cells 511 forming the sub-cell assembly 510 may experience thermal runaway phenomenon. Due to the thermal runaway, exhaust gas generated in the battery cells 511 may leak into the battery area BA.

The busbar assembly 520 may comprise a gas exhaust guide hole 523. The gas exhaust guide hole 523 may be formed in the busbar frame 521. The gas exhaust guide hole 523 may be formed to penetrate both surfaces of the busbar frame 521. A plurality of gas exhaust guide holes 523 may be provided. The gas exhaust guide holes 523 may be disposed in the stacking direction of the plurality of battery cells 511. The gas exhaust guide holes 523 and the busbar holes 522H may be spaced apart in one direction. For example, the gas exhaust guide holes 523 and the busbar holes 522H may be arranged alternately along the front-rear direction.

The gas exhaust guide hole 523 may be in communication with or connected to a space between the battery cells 511. The gas exhaust guide hole 523 may be in communication with the space on one side of an adjacent battery cell 511 that is in contact with the cell buffer member 513. For example, the gas exhaust guide hole 523 may be in communication with a space enclosed by the battery cell tab 511T of an adjacent pair of battery cells 511, the busbar frame 521, and an end of the battery cell 511.

Exhaust gas generated from the battery cell 511 may flow through the gas exhaust guide hole 523 to the outer exhaust frame 120 and the partition exhaust frame 220. A portion of the exhaust gas may flow into the first exhaust passage 150 through the first exhaust control valve 160. Another portion of the exhaust gas may flow into the second exhaust passage 250 through the second exhaust control valve 260. For example, exhaust gas discharged to one side of the battery cell 511 disposed in the second battery area BA2 may flow into the second exhaust passage 250 of the partition frame 200. Exhaust gas discharged to the other side of the battery cell 511 may flow into the first exhaust passage 150 of the outer frame 100. For example, exhaust gas discharged to one side of the battery cell 511 disposed in the first battery area BA1 may flow into the first exhaust passage 150 of the outer frame 100. Exhaust gas discharged to the other side of the battery cell 511 may flow into the second exhaust passage 250 of the partition frame 200.

According to the present disclosure, the exhaust passages 150 and 250 respectively formed in the outer exhaust frame 120 and the partition exhaust frame 220 may be utilized as an exhaust gas space. In the event of thermal runaway occurring within the battery pack 1, the internal pressure of the battery pack 1 may be rapidly relieved through the exhaust passages 150 and 250.

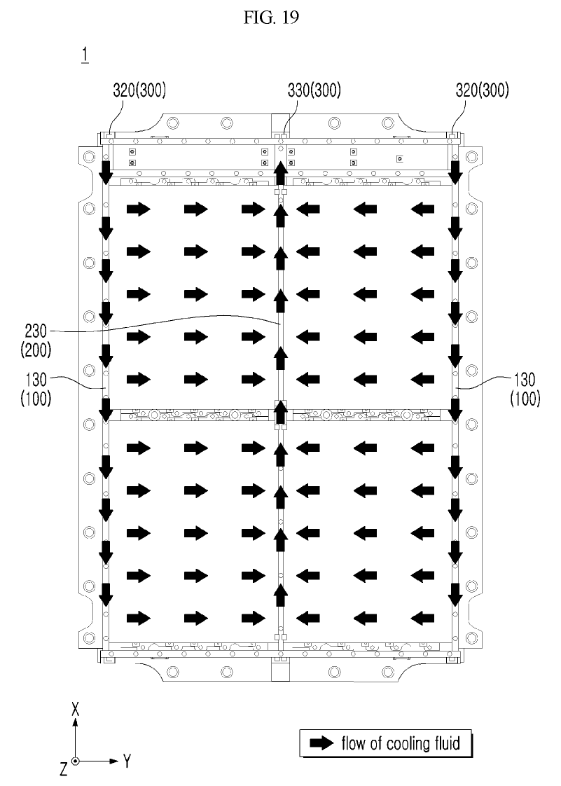

FIG. 19 is a view illustrating the flow of the cooling fluid in the main frame 10 forming the battery pack according to the present disclosure. Referring to FIG. 19, the cooling fluid introduced into the coolant inlet port 320 disposed on the front of the battery pack 1 may be discharged through the coolant outlet port 330 disposed on the front of the battery pack 1.

The cooling fluid introduced into the coolant inlet port 320 may flow into the coolant inlet passage 130 formed in the coolant inlet frame 110. The cooling fluid may be supplied to the first battery area BA1 and the second battery area BA2 through the first coolant outlet hole 112 in communication with the first coolant inlet passage 131. The cooling fluid may be supplied to the third battery area BA3 and the fourth battery area BA4 through the coolant outlet holes 112 and 113 in communication with the second coolant inlet passage 132.

The first coolant inlet passage 131 and the second coolant inlet passage 132 may be spaced apart from each other. The cooling fluid flowing through the coolant inlet passages 131 and 132 may be discharged through their respective coolant outlet holes 112 and 113 without mutual interference. The cooling fluid may be supplied to the battery area BA without loss of thermal energy.

The cooling fluid supplied to the battery area BA may absorb heat generated from the battery cell 511 while flowing through the cooling channel 512. The heated cooling fluid may flow to the front of the battery pack 1 through the coolant outlet passage 230 formed in the partition coolant frame 210. The cooling fluid may be discharged through the coolant outlet port 330 connected to the coolant outlet passage 230.

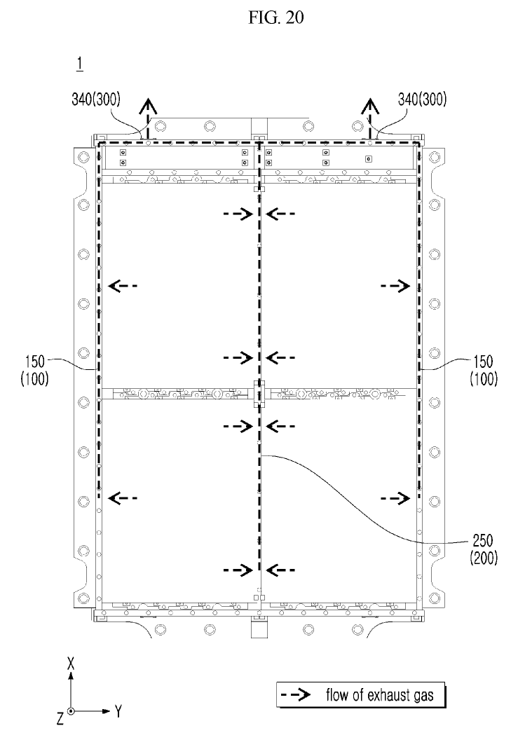

FIG. 20 is a view illustrating the flow of exhaust gas in the main frame 10 forming the battery pack according to the present disclosure.

Exhaust gas generated from the battery cell 511 may leak into the battery area BA due to thermal runaway. The exhaust gas generated from the battery cell 511 may be exhausted to the gas outlet port 340 through the outer exhaust frame 120 and the partition exhaust frame 220. The exhaust gas may be exhausted to the gas outlet port 340 via the first exhaust passage 150 and the second exhaust passage 250. The first exhaust passage 150 and the second exhaust passage 250 may be connected to the third through hole 313. The third through hole 313 may form a conduit connecting the exhaust passages 150 and 250 to the gas outlet port 340.

While the battery pack according to the embodiments of the present disclosure has been described as specific embodiments, these are merely examples, and the present disclosure is not limited thereto, and should be construed to have the broadest possible scope consistent with the basic concepts disclosed herein.

What is claimed is:

1. A battery pack comprising:
a pack frame including a main frame; and
a cell assembly accommodated in the pack frame,
wherein the main frame comprises:
an outer frame having a coolant inlet passage formed therein and disposed on one side of the cell assembly;
a partition frame disposed opposite the outer frame with respect to the cell assembly and having a coolant outlet passage formed therein; and
a front frame including a coolant inlet port in communication with the coolant inlet passage and a coolant outlet port in communication with the coolant outlet passage.

2. The battery pack according to claim 1, wherein the outer frame comprises a first exhaust passage spaced apart from the coolant inlet passage,
the partition frame comprises a second exhaust passage spaced apart from the coolant outlet passage, and
the front frame comprises a gas outlet port in communication with the first exhaust passage and the second exhaust passage.

3. The battery pack according to claim 2, wherein the front frame comprises a front frame body coupled to the outer frame and the partition frame, and
the front frame body comprises a third through hole configured to provide fluid communication between the gas outlet port and the first and second exhaust passages.

4. The battery pack according to claim 2, wherein the outer frame comprises:
a coolant inlet frame in which the coolant inlet passage is formed; and
an outer exhaust frame in which the first exhaust passage is formed.

5. The battery pack according to claim 3, wherein the third through hole comprises:
an exhaust connecting section formed in the front frame body;
an exhaust inlet hole configured to provide fluid communication between the exhaust connecting section and the first and second exhaust passages; and
an exhaust leakage hole configured to provide fluid communication between the exhaust connecting section and the gas outlet port.

6. The battery pack according to claim 4, wherein the partition frame comprises:
a partition coolant frame in which the coolant outlet passage is formed; and
a partition exhaust frame in which the second exhaust passage is formed.

7. The battery pack according to claim 6, wherein the outer frame comprises a first exhaust control valve penetrating and coupled to the outer exhaust frame, and
the partition frame comprises a second exhaust control valve penetrating and coupled to the partition exhaust frame.

8. The battery pack according to claim 1, wherein the main frame further comprises a wall frame connected to the outer frame and the partition frame, and
the wall frame comprises a front wall frame, a rear wall frame spaced apart from the front wall frame, and a middle wall frame disposed between the front wall frame and the rear wall frame.

9. The battery pack according to claim 8, wherein an electrical component is disposed in a space between the front frame and the front wall frame.

10. The battery pack according to claim 8, wherein the coolant inlet passage comprises:
a first coolant inlet passage fluidly connecting the front wall frame and the middle wall frame; and
a second coolant inlet passage fluidly connecting the front wall frame and the rear wall frame.

11. The battery pack according to claim 8, wherein the space between the front wall frame and the rear wall frame comprises a battery area through which a cooling fluid flows.

12. The battery pack according to claim 10, wherein the first coolant inlet passage and the second coolant inlet passage are formed at different positions in a height direction.

13. The battery pack according to claim 1, wherein the outer frame comprises:
a first outer frame defining one side of the pack frame; and
a second outer frame defining the other side of the pack frame,
wherein the partition frame is disposed between the first outer frame and the second outer frame.

14. The battery pack according to claim 1, wherein the cell assembly comprises a sub-cell assembly including a plurality of battery cells stacked in one direction and a cooling channel disposed between the plurality of battery cells,
wherein the cooling channel is in communication with the coolant inlet passage and the coolant outlet passage.

15. The battery pack according to claim 14, wherein the cooling channel comprises:
a cooling channel body extending in a transverse direction; and
a cooling channel hollow portion formed through the cooling channel body in the transverse direction.

16. The battery pack according to claim 14, wherein the cell assembly further comprises a busbar assembly connected to the sub-cell assembly,
wherein the busbar assembly comprises: a busbar frame; and
a busbar coupled to the busbar frame and electrically connected to at least one of the plurality of battery cells,
wherein a busbar hole formed in the busbar is in communication with the cooling channel and the coolant inlet passage.

17. The battery pack according to claim 15, wherein a plurality of cooling channel hollow portions are provided, and
the plurality of cooling channel hollow portions are spaced apart in a height direction.

18. The battery pack according to claim 1, wherein the pack frame further comprises a base frame coupled to the main frame and defining a lower surface of the pack frame.

19. The battery pack according to claim 18, wherein the base frame comprises:
a base center frame coupled to the outer frame and the partition frame; and
a base outer frame coupled along an edge of the base center frame.

20. The battery pack according to claim 1, further comprising a pack cover part configured to cover an upper surface of the pack frame,
wherein the pack cover part comprises: a pack cover plate; and
a pack cover cushioning material disposed between the pack cover plate and the cell assembly.
